(19) United States
(12) Patent Application Publication
(10) Pub. No.: US 2017/0192241 A1
(43) Pub. Date: Jul. 6, 2017

(54) OPTICAL IMAGING SYSTEM

(71) Applicant: Union Optech Co., Ltd., Zhongshan (CN)

(72) Inventor: Junqiang GONG, Zhongshan (CN)

(21) Appl. No.: 15/297,104

(22) Filed: Oct. 18, 2016

(30) Foreign Application Priority Data
Dec. 30, 2015 (CN) 201511033582.4

(51) Int. Cl. G02B 27/10; H04N 5/225; G02B 27/14

(52) U.S. Cl. CPC G02B 27/1066; G02B 27/144; H04N 5/2254

(57) ABSTRACT

An optical imaging system, including: an optical lens, a light splitting element including a light splitting surface, a first imaging element, and a second imaging element. The optical lens, the light splitting element, and the first imaging element are respectively arranged in a straight line. The light splitting surface of the light splitting element is inclined relative to the axis of the optical lens. The second imaging element is configured with a normal line thereof perpendicular to the straight line formed by the optical lens, the light splitting element, and the first imaging element, to receive a reflected light from the light splitting element.

### CROSS-REFERENCE TO RELATED APPLICATIONS

Pursuant to 35 U.S.C. §119 and the Paris Convention Treaty, this application claims the benefit of Chinese Patent Application No. 201511033582.4 filed Dec. 30, 2015, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to an optical imaging system.

Description of the Related Art

Typically, to acquire high quality imaging in dark conditions, the lens of an optical system is equipped with an IR-cut day/night switching device to enable visible light and infrared light to be confocal. This increases the design difficulty, increases the production cost of the optical lens, and the imaging effect is lacking.

### SUMMARY OF THE INVENTION

In view of the above-described problems, it is one objective of the invention to provide an optical imaging system that comprises an optical lens, a light splitting element, a first imaging system, and a second imaging system. In use, an incident light is focused by the optical lens and transmitted to a light splitting surface of the light splitting element to produce two light beams The two light beams are then transmitted to the first imaging element and the second imaging element, respectively. Images formed on the first imaging element and the second imaging element are synthesized by software to produce an image of high quality having high resolution and true color. The optical imaging system of the invention has simple design and can be applied in different environment conditions, such as the security monitoring and vehicle photography for acquiring high-quality images.

To achieve the above objective, in accordance with one embodiment of the invention, there is provided an optical imaging system. The optical imaging system comprises: an optical lens, a light splitting element comprising a light splitting surface, a first imaging element, and a second imaging element. The optical lens, the light splitting element, and the first imaging element are arranged in a straight line in that order. The light splitting surface of the light splitting element is inclined relative to an axis of the optical lens. The second imaging element is configured with a normal line thereof perpendicular to the straight line formed by the optical lens, the light splitting element, and the first imaging element, to receive a reflected light from the light splitting element.

In a class of this embodiment, the light splitting element is an inclinedly arranged planar light splitting element. The first imaging element is a resolution imaging element, and the second imaging element is a color imaging element.

In a class of this embodiment, the light splitting element is an inclinedly arranged planar light splitting element. The first imaging element is a color imaging element, and the second imaging element is a resolution imaging element.

In a class of this embodiment, an angle between an axis of the optical lens and the light splitting element is 45°.

In a class of this embodiment, the light splitting element is a prism-type light splitting element. The first imaging element is a resolution imaging element, and the second imaging element is a color imaging element.

In a class of this embodiment, the light splitting element is a prism-type light splitting element. The first imaging element is a color imaging element, and the second imaging element is a resolution imaging element.

In a class of this embodiment, an angle between the axis of the optical lens and the light splitting surface of the prism-type light splitting element is 45°.

In a class of this embodiment, the optical lens is a fixed-focus optical lens or a zoom optical lens.

Advantages of the optical imaging system according to embodiments of the invention are summarized as follows:

1. The first imaging element and the second imaging element are employed. Images formed on the first imaging element and the second imaging element are synthesized by software so as to produce an image of high quality having high resolution and true color. The optical imaging system of the invention has simple designed structure and can be applied in different conditions, such as the security monitoring and vehicle photography for acquiring high-quality images.

2. The light splitting element is employed, and the light splitting surface is inclinedly arranged relative to the axis of the optical lens, so that the transmission and/or reflection of the incident light of different wave lengths and different spectrums is realized.

### BRIEF DESCRIPTION OF THE DRAWINGS

The invention is described hereinbelow with reference to the accompanying drawings, in which:

FIG. 1 is a structure diagram of an optical imaging system in accordance with Examples 1-2; and

FIG. 2 is a structure diagram of an optical imaging system in accordance with Examples 3-4.

### DETAILED DESCRIPTION OF THE EMBODIMENTS

For further illustrating the invention, experiments detailing an optical imaging system are described below. It should be noted that the following examples are intended to describe and not to limit the invention.

An optical imaging system comprises an optical lens 1, a light splitting element 1, a first imaging element 3 respectively arranged from the left to the right. The optical lens 1 is a fixed-focus optical lens or a zoom optical lens. The light splitting element 2 is provided with a light splitting surface 21 that is inclinedly arranged relative to an axis of the optical lens 1. A second imaging element 4 is arranged above the light splitting surface 21. In use, an incident light is focused by the optical lens and transmitted to the light splitting surface 21 of the light splitting element 2 to produce two light beams. The two light beams are then transmitted to the first imaging element 3 and the second imaging element 4, respectively. Images formed on the first imaging element 3 and the second imaging element 4 are synthesized by software so as to produce an image of high quality having high resolution and true color. The optical imaging system of the invention has simple designed structure and can be applied in different environment conditions, such as the security monitoring and vehicle photography for acquiring high-quality images.

Optionally, an angle between the light splitting surface 21 and the axis of the optical lens 1 is 45°.

### EXAMPLE 1

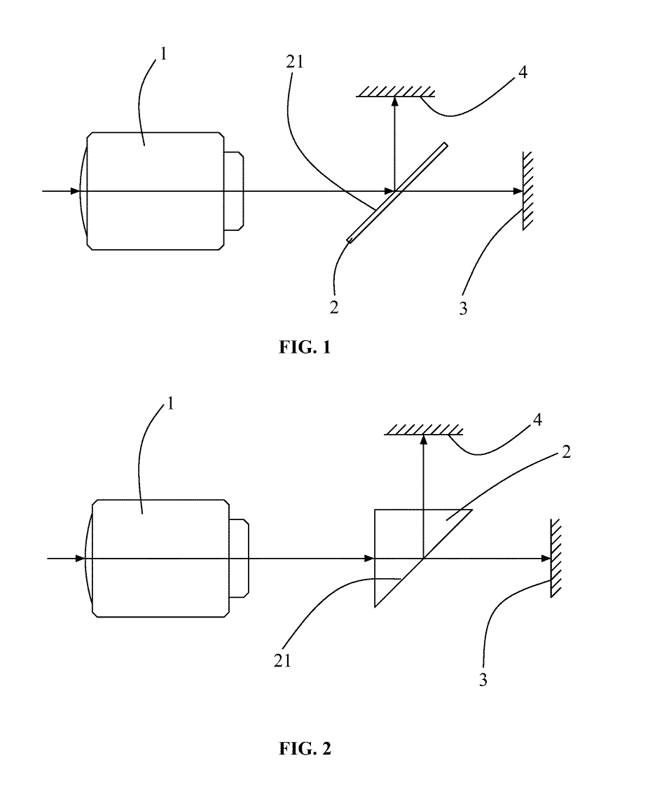

As shown in FIG. 1, the light splitting element 2 is a planar light splitting element that is inclinedly arranged at an angle of 45° relative to the axis of the optical lens 1. The first imaging element 3 is a high resolution imaging element, and the second imaging element 4 is a color imaging element. An incident light is focused by the optical lens 1, and an emergent light passes through the light splitting surface 21 of the planar light splitting element. According to a spectrum of the light, a part of the light is transmitted to the high resolution imaging element functioning as the first imaging element 3, and the other part of the light is reflected to the color imaging element functioning as the second imaging element 4.

### EXAMPLE 2

As shown in FIG. 1, the light splitting element 2 is a planar light splitting element that is inclinedly arranged at an angle of 45° relative to the axis of the optical lens 1. The first imaging element 3 is a color imaging element, and the second imaging element 4 is a high resolution imaging element. An incident light is focused by the optical lens 1, and an emergent light passes through the light splitting surface 21 of the planar light splitting element. According to a spectrum of the light, a part of the light is transmitted to the color imaging element functioning as the first imaging element 3, and the other part of the light is reflected to the high resolution imaging element functioning as the second imaging element 4.

### EXAMPLE 3

As shown in FIG. 2, the light splitting element 2 is a prism-type light splitting element. A light splitting surface of the prism-type light splitting element is inclinedly arranged at an angle of 45° relative to the axis of the optical lens 1. The first imaging element 3 is a high resolution imaging element, and the second imaging element 4 is a color imaging element. An incident light is focused by the optical lens 1, and an emergent light passes through the light splitting surface 21 of the prism-type light splitting element. According to a spectrum of the light, a part of the light is transmitted to the high resolution imaging element functioning as the first imaging element 3, and the other part of the light is reflected to the color imaging element functioning as the second imaging element 4.

### EXAMPLE 4

As shown in FIG. 2, the light splitting element 2 is a prism-type light splitting element. A light splitting surface of the prism-type light splitting element is inclinedly arranged at an angle of 45° relative to the axis of the optical lens 1. The first imaging element 3 is a color imaging element, and the second imaging element 4 is a high resolution imaging element. The incident light is focused by the optical lens 1, and an emergent light passes through the light splitting surface 21 of the prism-type light splitting element. According to a spectrum of the light, a part of the light is transmitted to the color imaging element functioning as the first imaging element 3, and the other part of the light is reflected to the high resolution imaging element functioning as the second imaging element 4.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An optical imaging system, comprising:
a) an optical lens;
b) a light splitting element, the light splitting element comprising a light splitting surface;
c) a first imaging element; and
d) a second imaging element;
wherein
the optical lens, the light splitting element, and the first imaging element are arranged in a straight line in that order;
the light splitting surface of the light splitting element is inclined relative to an axis of the optical lens; and
the second imaging element is configured with a normal line thereof perpendicular to the straight line formed by the optical lens, the light splitting element, and the first imaging element, to receive a reflected light from the light splitting element.

2. The system of claim 1, wherein the light splitting element is an inclinedly arranged planar light splitting element; and the first imaging element is a resolution imaging element, and the second imaging element is a color imaging element.

3. The system of claim 1, wherein the light splitting element is an inclinedly arranged planar light splitting element; and the first imaging element is a color imaging element, and the second imaging element is a resolution imaging element.

4. The system of claim 2, wherein an angle between an axis of the optical lens and the light splitting element is 45°.

5. The system of claim 3, wherein an angle between an axis of the optical lens and the light splitting element is 45°.

6. The system of claim 1, wherein the light splitting element is a prism-type light splitting element; and the first imaging element is a resolution imaging element, and the second imaging element is a color imaging element.

7. The system of claim 1, wherein the light splitting element is a prism-type light splitting element; and the first imaging element is a color imaging element, and the second imaging element is a resolution imaging element.

8. The system of claim 6, wherein an angle between the axis of the optical lens and the light splitting surface of the prism-type light splitting element is 45°.

9. The system of claim 7, wherein an angle between the axis of the optical lens and the light splitting surface of the prism-type light splitting element is 45°.

10. The system of claim 1, wherein the optical lens is a fixed-focus optical lens or a zoom optical lens.

11. The system of claim 2, wherein the optical lens is a fixed-focus optical lens or a zoom optical lens.

12. The system of claim 3, wherein the optical lens is a fixed-focus optical lens or a zoom optical lens.

13. The system of claim 4, wherein the optical lens is a fixed-focus optical lens or a zoom optical lens.

14. The system of claim 5, wherein the optical lens is a fixed-focus optical lens or a zoom optical lens.

15. The system of claim 6, wherein the optical lens is a fixed-focus optical lens or a zoom optical lens.

16. The system of claim 7, wherein the optical lens is a fixed-focus optical lens or a zoom optical lens.

17. The system of claim 8, wherein the optical lens is a fixed-focus optical lens or a zoom optical lens.

18. The system of claim 9, wherein the optical lens is a fixed-focus optical lens or a zoom optical lens.
